(19) United States
(12) Patent Application Publication
(10) Pub. No.: US 2002/0083290 A1
(43) Pub. Date: Jun. 27, 2002

(54) Database management system

(76) Inventor: John M. Mocenigo, Pottersville, NJ (US)

Correspondence Address: BANNER & WITCOFF, 1001 G STREET N W, SUITE 1100, WASHINGTON, DC, 20001, US

(21) Appl. No.: 09/741,100

(22) Filed: Dec. 21, 2000

(51) Int. Cl. G06F 13/00; G06F 12/14

(52) U.S. Cl. 711/202; 711/156

(57) ABSTRACT

A method and apparatus for data retrieval in an analysis system is disclosed. A request for data specified by at least one parameter is received. It is then determined if the requested data has been previously requested within a predetermined period of time. The requested data is retrieved from a database if the requested data was not previously requested within the predetermined period of time. The requested data is stored in n-dimensional parameter space, wherein the at least one parameter points to the address where the requested data is stored. Requests for the requested data received within said predetermined period of time are mapped to the address in n-dimensional space.

### FIELD OF THE INVENTION

The invention relates to a method and apparatus for storing information, and particularly to data storage system which maps identical data requests to the same place in n-dimensional space.

### BACKGROUND OF THE INVENTION

Because immediate access to information has become a necessity in virtually all fields of endeavor, including business, finance and science, telecommunication system usage is increasing at a substantial rate. With the increase in overall usage, however, the amount of information generated by the telecommunication systems has exploded. Typically, each call made on a telecommunication system generates a variety of information, for example, billing information and other information regarding each specific call. All of this information can be analyzed for a variety of purposes such as billing, fraud control, detecting trends and characteristics of each ANI in a telecommunication system. For each of these purposes, a processor in the analysis system accesses the call information, e.g., call detail, specifying various call parameters. For example, the analysis system may want to analyze the 100 most recent calls for a particular ANI. The call detail information, which is stored in the telecommunication system, is then gathered from the database and sent to the analysis system requesting the information. The gathering process takes time and resources. As a result, it would be advantageous to have a system and method of allowing different requests for the same data to share in the first retrieval of the information rather than requiring the system to have to retrieve the information every time a request is made for the information.

### SUMMARY OF THE INVENTION

It is an object of the present invention to provide a new method and apparatus for storing results of a data request so that a subsequent data request for the same data can be filled without requiring the same data retrieval process generated by the first request. According to one embodiment of the invention, a data management system is provided that maps requests for the same data to a location where the retrieved data is stored thereby alleving the system from having to retrieve the data from the main database every time the data is requested.

A method and apparatus for data retrieval in an analysis system is disclosed. A request for data specified by at least one parameter is received. It is then determined if the requested data has been previously requested within a predetermined period of time. The requested data is retrieved from a database if the requested data was not previously requested within the predetermined period of time. The requested data is stored in n-dimensional parameter space, wherein the at least one parameter points to the address where the requested data is stored. Requests for the requested data received within said predetermined period of time are mapped to the address in n-dimensional space.

### BRIEF DESCRIPTION OF THE DRAWINGS

The foregoing summary of the invention, as well as the following detailed description of the preferred embodiments, is better understood when read in conjunction with the accompanying drawings, which are included by way of example, and not by way of limitation with regard to the claimed invention.

FIG. 1 is a block diagram of a telecommunication system implementing one embodiment of the invention;

FIG. 2 illustrates a part of a streamer according to one embodiment of the invention;

FIG. 3 is a flow chart illustrating the operation of the data management system according to one embodiment of the invention; and

FIG. 4 illustrates a data management system according to one embodiment of the invention.

### DETAILED DESCRIPTION

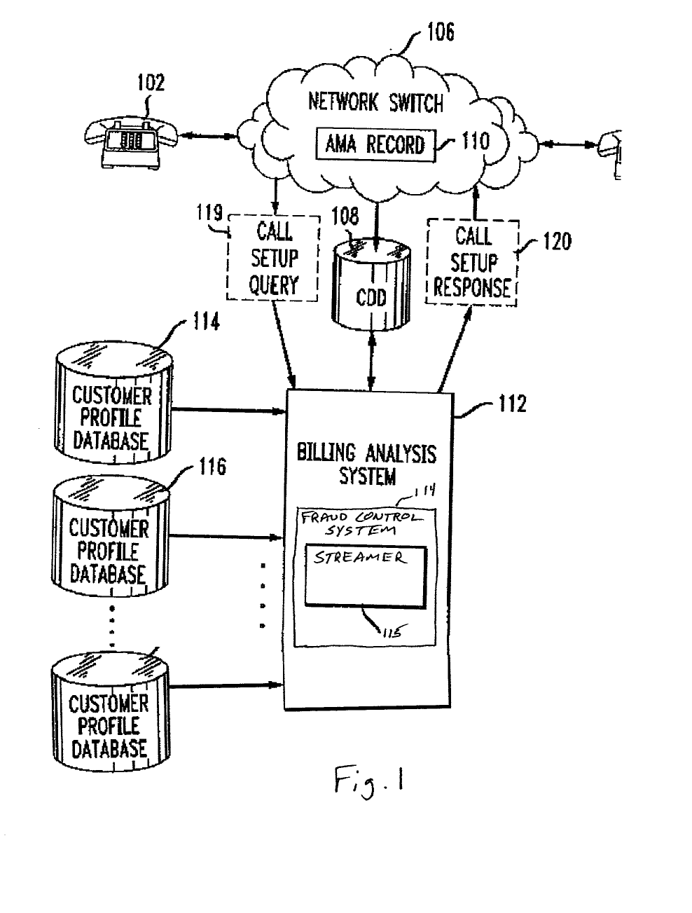

Referring to FIG. 1 there is shown a block diagram of a telephone system in accordance with one embodiment of the present invention. There is shown a calling telephone 102, a called telephone 104, a telephone network switch 106 and a Call Detail Database (CDD) 108. An Automatic Message Accounting (AMA) record, represented by a block 110, is also shown. As indicated by the figure, a billable call may be initiated at telephone 102 and routed through switch 106, e.g., an AT&T 4ESS switch, to telephone 104. The switch generates AMA record 110, which includes the information necessary to rate the call. The AMA record is passed to the CDD 108. It should be noted here that there are an abundance of protocols and transmission media that may be used for passing the data from the switch to the CDD. For example, suitable protocols include the well known File Transfer Protocol (FTP) and Transmission Control Protocol/Internet Protocol; and suitable transmission media include twisted shielded pair wires, fiber optic lines, coaxial cable, and wireless links. Moreover, these protocols and media are suitable for use in all data transfers and queries hereinafter described.

In any event, once the AMA record has been passed to the CDD, it is available for use in pricing the call. To this end, the AMA record is passed to a billing analysis system 112, which may be a general purpose computer capable of running the software necessary to implement the invention. The analysis system can be a billing analysis system, a fraud control system and/or some other system which is used to analyze call information. The analysis system applies any customer specific billing parameters to the AMA record to produce a processed AMA record. It then passes both the AMA record and the processed AMA record back to the CDD for storage.

A billing analysis system may include a fraud control system 114, but it will be understood that the fraud control system can be located at other places in the telephone network. The fraud control system gets a feed of the call detail records for all calls recorded on the telephone network from the CCD. The fraud control system processes those records using a streamer 115 that pulls up multiple subsets of the original stream of calls, wherein each subset typically involves a type of call such as international, credit card, etc., and processes each subset through routines that check for thresholds that may be exceeded. The result of exceeding a threshold may result in an alert signal being generated.

The streamer implements an on-the-fly database wherein the data flows by and the streamer extracts interesting pieces as they appear. There can be a number of independent modules in the streamer. When the streamer starts, it calls an initialization routine provided with each module. When each record is processed, a per-record routine is called for each module. This processing routine can elect to do something with the record, for example, write it to a file, write a partial record to a file, accumulate some values, or simply ignore it. Finally when the streamer stops, a module-specific wrap-up routine is called for each module. Typically, the initialization routine opens files, the wrap-up routine prints results or closes files. Modules can be toggled on and off by files.

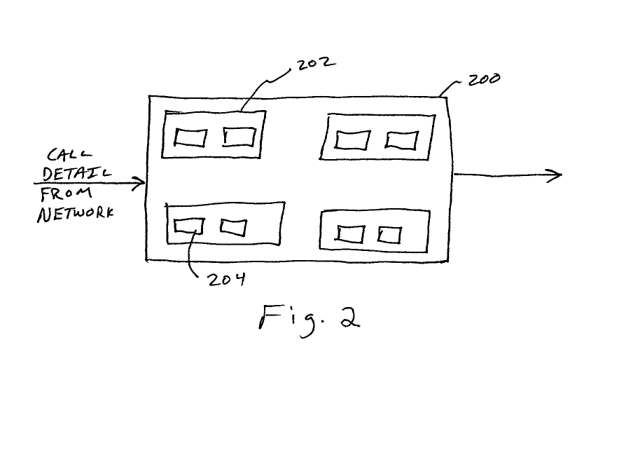

When processing a huge stream of data, for example 35GB per day of call detail, it is important to have a robust technique of operation. The streamer 116 uses a portion of the file system called a hose 200, where all data flows through as illustrated in FIG. 2. Data does not permanently stay here. The hose is constructed as a uniform set of directories 202, each with the same structure. They contain subdirectories 204 named incoming, ready, running, and done as well as files that hold state, named Stop and Log. Call detail is presented to the streamer file by file. Each file arrives in an incoming directory and stays there until it is complete, i.e., the processing that produced it terminates successfully. A completed file is moved, using the operating system “mv” function, into a ready directory. All processing is done on files in “ready” directories. If prior processing is interrupted or incomplete due to system failure, file fragments may remain in incoming directories, but they are never processed. When it is time to process the files in the “ready” directory, they are moved into the “running” directory and processed. The processing may, in turn, create new files in incoming directories of other hose parts. If the processing is successful, the files are moved from “running” to “done” directories. Typically, only the most recent files are kept in the “done” directories. All processing is logged in the Log file. If an error occurs, the “stop” file is turned on in the hose part, stopping any further processing there. This hose paradigm leads to easy implementation of large systems, and provides robustness through the operating system.

According to one embodiment of the invention, a novel data retrieval algorithm can be used in the case management section of the analysis system of, for example a telecommunication system, but the invention is not limited thereto. It allows for efficient and timely data retrieval from multiple, asynchronous requesters with coherent status reporting and data refresh. Data retrieval requests are mapped to a location in n-dimensional parameter space. Any request that maps to the same location can share in the retrieved information. A placeholder mechanism permits requestors to queue until the initial data request is satisfied. A parallel parameter space provides a channel for error messaging to requesters. A time-out can be specified for clearing the channels so that a subsequent request will trigger a fresh data retrieval thereby providing a configurable window of currency for the retrieved data.

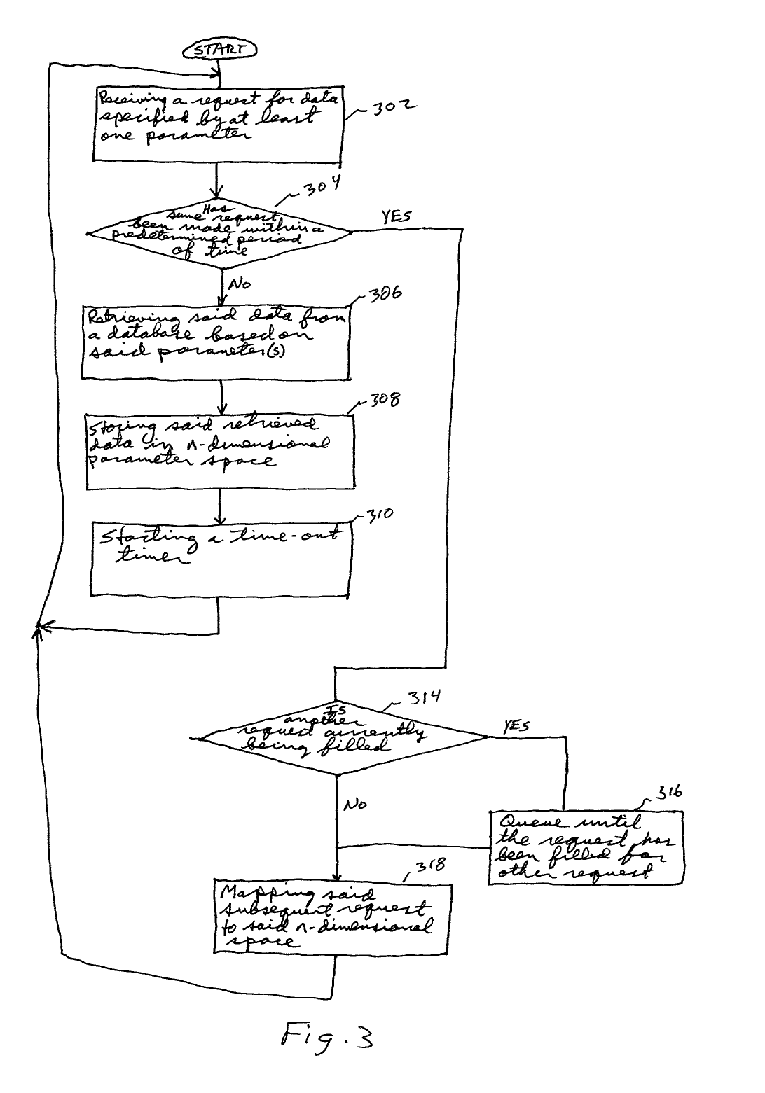

FIG. 3 illustrates the operation of the data management system according to one embodiment of the invention. In step 302, the data management system receives a request for data, such as call detail information for a specific ANI in a telecommunication system. The requested data is specified by at least one parameter in the data request. The system then determines whether the same data had been previously requested within a predetermined period of time, for example, in the last 15 minutes, in step 304. If the data had not been requested within the predetermined period of time, the system retrieves the data from a database based on the specified parameters in step 306. The retrieved data is then stored in n-dimensional parameter space in step 308, wherein the specific parameters used to request the data points to the address where the data is stored. For example, if the requested data is for a specific ANI for the most recent 100 calls, the address for where the data is stored is based on the specific ANI and the parameter specifying the most recent 100 calls. After the retrieved data has been stored, a time-out timer is started for the predetermined period of time in step 310.

If it is determined in step 304 that the same data has been requested within the predetermined period of time, the data request can be mapped directly to the n-dimensional space where the retrieved data is stored. Alternatively, the system can first determine whether another request for the requested data is currently being filled in step 314. If another request for the requested data is not being filled, the data request is mapped to the n-dimensional space where the retrieved data is stored in step 318. However, if it is determined that another request for the data is currently being filled, the data request is queued until the other request is filled in step 316. It will be understood that the queue can contain multiple requests for the retrieved data and the requests will be filled in a first in first out manner in step 318.

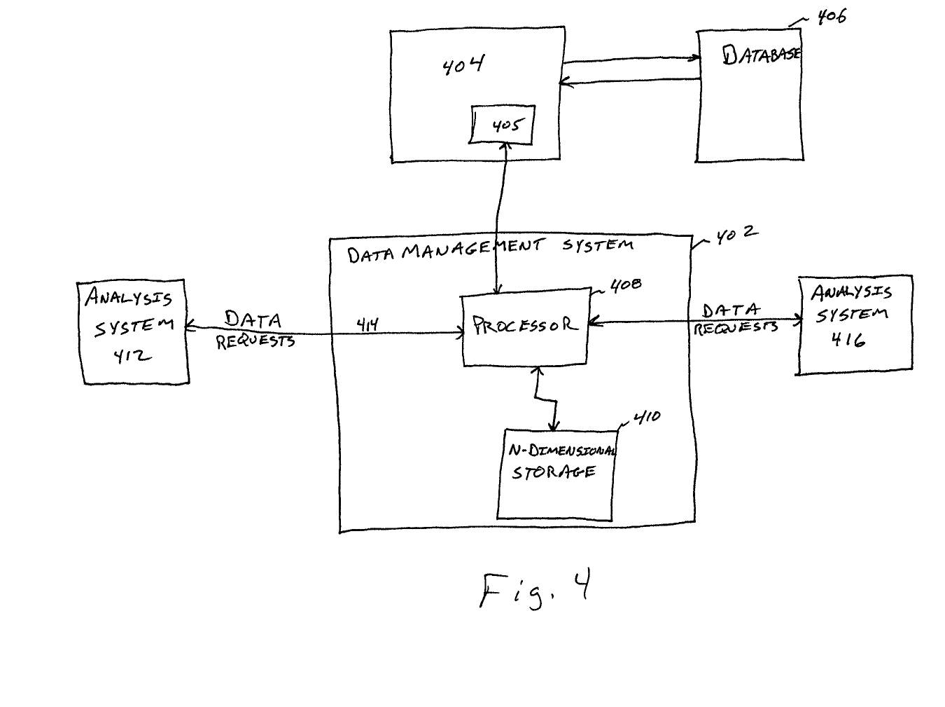

FIG. 4 illustrates a data management system according to one embodiment of the invention which uses the operation set forth above with respect to FIG. 3. The data management system 402 comprises at least one processor 408 and at least one n-dimensional data storage element 410. The processor is connected to a system which is generating the data, such as a telecommunication system 404. The processor 408 can be connected to a processor 405 in the system 404 or can be directly connected to the system database 406. During operation data gathered by the system 404 is stored in the database 406. When the processor 408 receives a request 414 for data from system 404 from an analysis system 412, for example, the processor sends the request to the system 404 and the requested data is pulled from the database 406 and sent to the processor 408. The processor then stores the requested information in the n-dimensional storage element 410 using the parameters used to request the data as an address. The processor then sends the requested data to the analysis system 412. If a second data request 418 for the same data is received within a predetermined time from when the data was first stored in the n-dimensional storage element 410, the processor maps the request to the address in the n-dimensional storage element and the requested data is forwarded to the analysis system 416. Thus, the data management system is capable of filling the second and subsequent requests for data without requesting the data from the system 404. This has the advantage of speeding up the time it takes to fill the request while reducing the number of times the processor 408 has to request information from the system 404.

Although preferred embodiments of the method and apparatus of the present invention have been illustrated in the accompanying Drawings and described in the foregoing Detailed Description, it is understood that the invention is not limited to the embodiments disclosed, but is capable of numerous rearrangements, modifications, and substitutions without departing from the spirit or scope of the invention as set forth and defined by the following claims.

We claim:

1. A method for data retrieval in an analysis system, comprising the steps of:
receiving a request for data specified by at least one parameter;
determining if said requested data has been previously requested within a predetermined period of time;
retrieving said requested data from a database if the requested data was not previously requested within said predetermined period of time;
storing said requested data in n-dimensional parameter space, wherein said at least one parameter points to the address where the requested data is stored; and
mapping requests for said requested data received within said predetermined period of time to said address in n-dimensional space.

2. The method for data retrieval according to claim 1, wherein requestors are queued until an initial data request is retrieved.

3. The method for data retrieval according to claim 1, further comprising the step of:
removing the requested data from the n-dimensional space at the end of said predetermined period of time.

4. The method for data retrieval according to claim 1, further comprising the step of:
providing a parallel parameter space for providing error messaging to requesters.

5. The method for data retrieval according to claim 1, further comprising the steps of:
determining if a previous request for said requested data is currently being filled; and
queuing the data request until said previous request has been filled.

6. A data management system for data retrieval in an analysis system, comprising:
means for receiving a request for data specified by at least one parameter;
means for determining if said requested data has been previously requested within a predetermined period of time;
means for retrieving said requested data from a database if the requested data was not previously requested within said predetermined period of time;
means for storing said requested data in n-dimensional parameter space, wherein said at least one parameter points to the address where the requested data is stored; and
means for mapping requests for said requested data received within said predetermined period of time to said address in n-dimensional space.

7. The data management system according to claim 6, wherein requestors are queued until an initial data request is retrieved.

8. The data management system according to claim 6, further comprising:
means for removing the requested data from the n-dimensional space at the end of said predetermined period of time.

9. The data management system according to claim 6, further comprising:
means for providing a parallel parameter space for providing error messaging to requesters.

10. The data management system according to claim 6, further comprising:
means for determining if a previous request for said requested data is currently being filled; and
queuing the data request until said previous request has been filled.

11. A data management system connected to a data collection system, comprising:
a processor connected to said data collection system and at least one analysis system;
at least one n-dimensional storage means connected to said processor for storing requested data,
wherein when said process receives a request for data specified by at least one parameter from said at least analysis system, said processor determines if said requested data has been previously requested within a predetermined period of time, and retrieves said requested data from a database in said data collection system if the requested data was not previously requested within said predetermined period of time, the processor then stores said requested data in n-dimensional storage means, wherein said at least one parameter points to the address where the requested data is stored, and maps requests for said requested data received within said predetermined period of time to said address in n-dimensional storage means.

12. The data management system according to claim 11, wherein requesters are queued until an initial data request is retrieved.

13. The data management system according to claim 11, wherein said processor removes the requested data from the n-dimensional storage means at the end of said predetermined period of time.

14. The data management system according to claim 11, further comprising:
means for providing a parallel parameter space for providing error messaging to requesters.

15. The data management system according to claim 11, further comprising:
means for determining if a previous request for said requested data is currently being filled; and
queuing the data request until said previous request has been filled.
